(19) United States
(12) Patent Application Publication
(10) Pub. No.: US 2008/0143487 A1
(43) Pub. Date: Jun. 19, 2008

(54) SYSTEM AND METHOD FOR ENABLING INTERRUPTS FOR RFID TAGS

(75) Inventor: Robert William Hulvey, Redondo Beach, CA (US)

Correspondence Address: LAW OFFICE OF DUANE S. KOBAYASHI, P.O. Box 4160, Leesburg, VA, 20177, US

(73) Assignee: Broadcom Corporation, Irvine, CA (US)

(21) Appl. No.: 11/956,982

(22) Filed: Dec. 14, 2007

Related U.S. Application Data
(60) Provisional application No. 60/875,544, filed on Dec. 19, 2006.

(51) Int. Cl. H04B 7/00

(52) U.S. Cl. 340/10.34

(57) ABSTRACT

A system and method for enabling interrupts for RFID tags. An RFID tag is provided with an output signal that can notify another chip in a system, or another function within the same IC, that a read of the RFID's information has taken place. In one embodiment, the output signal would awaken a microcontroller from a low power sleep mode. The awakened microcontroller can be designed to perform a higher-level function than that supported by the RFID tag.

This application claims priority to provisional application No. 60/875,544, filed Dec. 19, 2006, which is incorporated by reference herein, in its entirety, for all purposes.

### BACKGROUND

1. Field of the Invention

The present invention relates generally to RFID tags and, more particularly, to a system and method for enabling interrupts for RFID tags.

2. Introduction

A Radio Frequency Identification (RFID) system enables data to be transmitted by a RFID tag using electromagnetic waves, which are read by an RFID reader. Some RFID tags employ magnetically coupled communications means such as so-called “near field communication” which typically operates at 13.56 MHz. Others utilize radio waves at frequencies such as 900 MHz or 2.4 GHz. Still others use capacitively coupled energy at various frequencies. In various applications, the data transmitted by the RFID tag can provide information such as identification information, location information, or information about the tagged product (e.g., price, color, date of purchase, etc). RFID tags have proved useful in various tracking and access applications.

RFID tags typically contain a transponder and memory that has unique information (e.g., electronic product code) stored therein. The RFID reader, which contains a transceiver and decoder, emits a signal activating the RFID tag so it can read data from the RFID tag memory. The RFID reader then decodes the data encoded in the memory and passes the data to a host system.

Two different types of RFID tags exist: passive RFID tags and active RFID tags. Passive RFID tags require no internal power source. The minute electrical current induced in the antenna by the incoming radio frequency signal provides enough power for RFID tag circuitry to power up and transmit a response. Active RFID tags, on the other hand, have their own internal power source that is used to power the circuitry that generates the output signal. Due to the internal power source, active RFID tags are able to receive signals with smaller power levels and able to transmit signals at higher power levels, thereby accommodating longer transmission distances.

RFID tags are finding increasing applicability in short-range wireless applications. What is needed therefore is a mechanism that enables RFID tags to interoperate with other functions in a host portable device while also maintaining low-power operating modes in such portable devices.

### SUMMARY

A system and/or method for enabling interrupts for RFID tags, substantially as shown in and/or described in connection with at least one of the figures, as set forth more completely in the claims.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an embodiment of a RFID tag that generates an interrupt signal.

FIG. 2 illustrates a flowchart of a process of enabling peer-to-peer communication between devices.

FIG. 3 illustrates an embodiment of a mechanism for activating a microcontroller from a low power mode.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

RFID tags provide a flexible communication mechanism by which information can be read from a memory using a portable reader device. This communication mechanism typically does not consume significant amounts of power. This is especially true in those situations where the RFID tag is a passive device.

RFID tags can be integrated in various portable devices. For example, an RFID tag can be incorporated into a personal digital assistant or mobile phone for use in an electronic commerce application. In this application, the RFID tag memory can store financial information that can be read by an RFID reader at a point of sale. RFID tags can also be integrated in portable devices that are designed to operate in a short-range wireless application (e.g., Bluetooth, Wi-Fi, etc.).

In the integration of RFID tags with a portable device, it is desirable that such integration enables RFID tag communication to occur with a minimum of power by the host device. For example, where the RFID tag communication is a precursor to communication by the host device, it is desirable that the host device be active only when it is needed. In other words, the host device can remain in a low power sleep mode until one or more functions of the host device require activation. This serves to reduce the overall power requirement at the host device.

In this regard, it is a feature of the present invention that the RFID tag can be designed to alert another chip in the host device (or another function in the same IC) that a read of the RFID's information has taken place. Where the read of the RFID's information is a precursor to an activation of some part of the host device, this serves to reduce the overall power consumed by the host device.

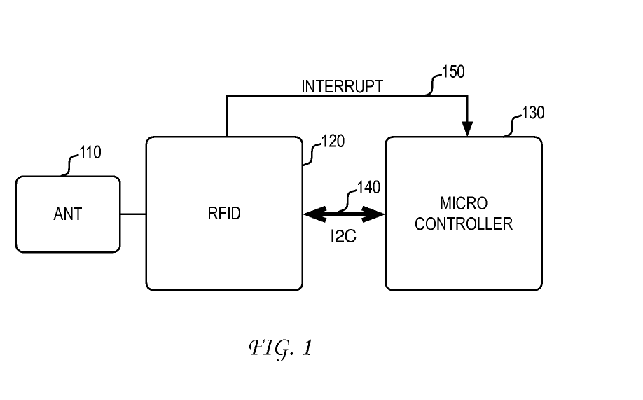

To illustrate this feature of the present invention, reference is now made to FIG. 1, which shows an embodiment of an RFID tag interrupt mechanism. In this embodiment, RFID tag 120 along with antenna 110 are integrated into a host device that also contains microcontroller 130. In one embodiment, RFID tag 120 is connected to microcontroller 130 via 12C bus 140. As would be appreciated, the host device can represent a portable device such as a mouse, keyboard, headset, mobile phone, personal digital assistant, or the like.

RFID tag 120 is also designed to produce an interrupt signal on signal line 150. In one embodiment, the interrupt signal is an open-drain signal. In general, the interrupt signal is designed to communicate to microcontroller 130 that a read of RFID tag 120 has taken place. This communication enables systems in low power modes to wake-up when the tag is read. In other words, by providing a wake-up/interrupt signal, the RFID tag allows other portions of a system to remain in a low-power “sleep” mode until the user wakes the device by reading the RFID tag. This is significant especially when considering passive RFID tags, which do not typically incorporate a mechanism for notifying other system components after a read has taken place.

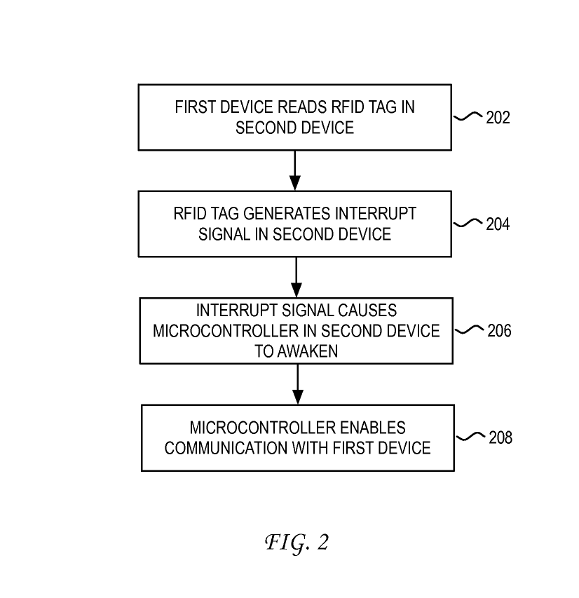

Reference is now made to the flowchart of FIG. 2 to illustrate the operation of such an interrupt mechanism. As illustrated, the process begins at step 202 where a first device (e.g., tag reader) reads RFID tag 120 that is contained in a second device (e.g., personal digital assistant). After the read of RFID tag 120 has taken place, RFID tag 120 would then generate an interrupt signal on signal line 150. At step 206, this interrupt signal would cause microcontroller 130 in the second device to awaken from a low power mode. Once awakened, microcontroller 130 can then initiate communication with the first device at step 208. This communication can be based on other portions of the second device that support more complex communication rates and capacities as compared to those supported by RFID tag 120. In one scenario, RFID tag 120 can contain configuration information for another radio technology such as Bluetooth or Wi-Fi that is supported by the second device. The following examples illustrate various uses of such an interrupt mechanism.

In one example, the host device is a Bluetooth mouse, keyboard or headset that incorporates a passive RFID tag containing configuration information. This configuration information can be stored in non-volatile memory (e.g., EPROM, Flash, etc.) that is fixed at a factory. These Bluetooth devices are typically battery powered. Thus, it is desirable to keep the device in a low power state where power consumption is minimized. In this example, a read of the passive RFID tag could occur when a user desires to pair the device to a PC or mobile phone. Upon the read of the passive RFID tag, the microcontroller in the Bluetooth device would then awaken to control the Bluetooth pairing process. Here, the microcontroller would remain in the low power state until a pairing process is actually initiated. In a conventional system, a user wishing to pair two Bluetooth devices must push a button or choose a menu option to place both devices to be paired in a mode in which pairing can be performed. With the present invention, the user may place the PC or mobile phone into pairing mode with menu option or button press and then bring the other device to be paired in close proximity to the PC or mobile phone to cause the pairing to occur, thus simplifying the user experience.

In another example, the host device is a mobile phone (or personal digital assistant) that stores information used for mobile payments (e.g., electronic wallet or credit-card). With a passive RFID tag, the host device may even be turned off when it is presented to a mobile payments terminal. After the mobile payments terminal reads the RFID tag, the interrupt signal would then trigger all or portions of the mobile phone to power-up to assist in the payments transaction. For example, the mobile phone can be configured to display a user interface that would enable the user to select the proper credit card to use. In one embodiment, the mobile phone can be configured to automatically select a given credit card based on the merchant being paid and may then leave the display powered off. As would be appreciated, various other forms of user customization can be programmed into the mobile phone to facilitate the mobile payments transaction. Whether or not the customizations require user input, the customizations would be controlled by the microcontroller in the mobile phone.

In yet another example, the RFID tag can be incorporated into a “smart poster” that is designed for any public user to access. Since the RFID tag typically has limited capacity, and limited data rates, the RFID tag can be used to facilitate a higher speed connection. For example, upon a read of the RFID tag by a user device such as a mobile phone (or personal digital assistant), the RFID tag would awaken another device that has a higher speed connection (e.g., Bluetooth or Wi-Fi), and also higher storage capability. Here, the initial read of the RFID tag could possibly enable the transfer of configuration information, while the higher speed connection would enable the transfer of the media information (e.g., text, audio, and video) relating to the subject being advertised. In this manner, the smart poster's more advanced functions would lay dormant until needed upon user request.

As has been described, the interrupt mechanism provides a low cost approach to interaction between a RFID tag and a microcontroller on a host device. This approach also obviates the need for a more costly active RFID device that can emulate a tag, or implement a peer-to-peer communication mode.

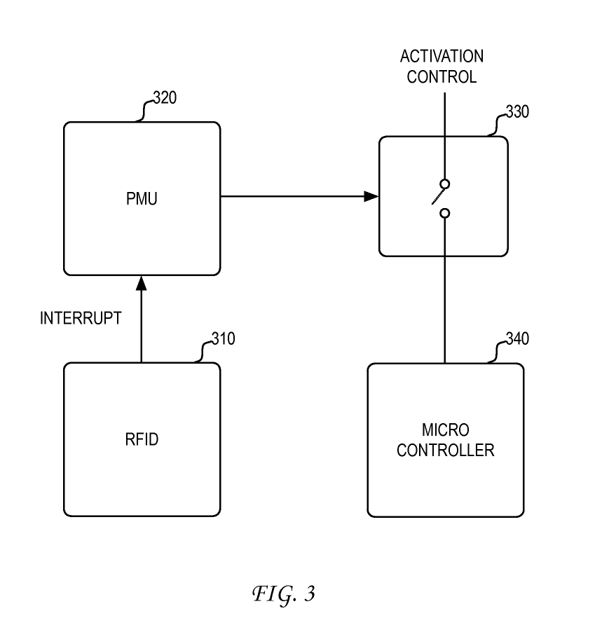

As would be appreciated, the RFID tag can be designed to generate various types of signals that can be used to directly or indirectly awaken a microcontroller (or other type of IC, or a separate function within a single IC). For example, in the embodiment of FIG. 3, RFID tag 310 is designed to output an interrupt signal to power management unit 320. Upon detection of the interrupt signal, power management unit 320 would activate switch 330 for connection of an activation signal to microcontroller 340. Upon receipt of the activation signal, microcontroller would then awaken from a low power mode. In other embodiments, microcontroller 340 can be replaced by other circuitry such as a digital ASIC (Application Specific IC) or an analog circuit.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. A wireless communication system, comprising:
an electronic device that operates in a low power sleep mode; and
a radio frequency identification tag that generates an output signal after said radio frequency identification tag is read, wherein said output signal triggers said electronic device to awaken from said low power sleep mode.

2. The wireless communication system of claim 1, wherein said electronic device is a Bluetooth device.

3. The wireless communication system of claim 1, wherein said electronic device is a mobile phone or personal digital assistant.

4. The wireless communication system of claim 1, wherein said electronic device is a Wi-Fi device.

5. The wireless communication system of claim 1, wherein said electronic device has a higher communication capacity then said radio frequency identification tag.

6. The wireless communication system of claim 1, wherein said radio frequency identification tag is a passive tag.

7. The wireless communication system of claim 1, wherein said output signal is an interrupt signal that is provided to a microcontroller in said electronic device.

8. The wireless communication system of claim 1, wherein said output signal is an interrupt signal that is provided to a power management unit in said electronic device.

9. A wireless communication method, comprising:
transmitting, by a radio frequency identification tag, information to a radio frequency identification tag reading device upon activation of said radio frequency identification tag by a reading device;
outputting, by said radio frequency identification tag, a signal after said radio frequency identification tag is read; and
awakening an electronic device from a low power sleep mode using said output signal.

10. The method of claim 9, wherein said radio frequency identification tag is a passive tag.

11. The method of claim 9, wherein said outputting comprises sending an interrupt signal to a microcontroller in said electronic device.

12. The method of claim 9, wherein said outputting comprises sending a signal to a power management unit in said electronic device.

13. The method of claim 9, further comprising activating a pairing process by said electronic device via Bluetooth.

14. The method of claim 9, further comprising activating a mobile payment process by said electronic device.

15. The method of claim 14, further comprising activating a mobile payment process by a mobile phone or personal digital assistant.

16. The method of claim 9, further comprising activating wireless communication by said electronic device.

17. The method of claim 16, further comprising activating wireless communication by a Wi-Fi device.

18. A peer-to-peer wireless communication method, comprising:
transmitting information from a radio frequency identification tag in a first device to a second device in response to a read by said second device;
awakening a peer-to-peer communication module in said first device from a low power mode upon said read by said second device; and
transmitting information to said second device using said peer-to-peer communication module of said first device.

19. The method of claim 18, wherein said radio frequency identification tag is a passive device.

20. The method of claim 18, wherein said peer-to-peer communication module is a Bluetooth or Wi-Fi module.

21. The method of claim 18, wherein said peer-to-peer communication module is a near field communication module with peer-to-peer communication capability.
